(19) United States
(12) Patent Application Publication
(10) Pub. No.: US 2019/0349683 A1
(43) Pub. Date: Nov. 14, 2019

(54) ADJUSTING AUDIO VOLUME FOR A PLURALITY OF ZONE SPEAKERS, SEPARATELY, WITHIN A PLURALITY OF ZONES IN REAL-TIME

(71) Applicant: INTERNATIONAL BUSINESS MACHINES CORPORATION, Armonk, NY (US)

(72) Inventors: Kelley L. Anders, East New Market, MD (US); Lisa Seacat DeLuca, Baltimore, MD (US); Jeremy R. Fox, Georgetown, TX (US); Jeremy A. Greenberger, San Jose, CA (US)

(21) Appl. No.: 15/978,284

(22) Filed: May 14, 2018

(51) Int. Cl. H04R 5/04; H04S 7/00; G10L 17/00

(52) U.S. Cl. CPC H04R 5/04; H04S 7/307; H04R 2430/01; H04R 2499/13; G10L 17/005

(57) ABSTRACT

A method for separately adjusting audio volume for a plurality of zone speakers in a space having a plurality of zones. The method detects one or more internet of things (IoT) devices within the plurality of zones. The method further associates the one or more detected IoT devices, within the plurality of zones, with a corresponding zone speaker. The method further adjusts the audio volume of the plurality of zone speakers, separately, based on one or more audio volume settings associated with the one or more detected IoT devices. The method is further capable of detecting an action state of one or more users, and adjusting the audio volume of the plurality of zone speakers, separately, based on one or more audio volume settings associated with the one or more users.

### BACKGROUND

The present disclosure relates generally to the field of cognitive computing, Internet of Things (IoT), and more particularly to data processing and dynamic adjustment of audio volume of multiple zone speakers corresponding to a detected internet of things (IoT) device, or user, within a zone.

Within today's IoT-connected world, individuals have come to expect that their goods and services be tailored to their specific profile (i.e., wants and needs). Individuals may have varying sensory needs and preferences, particularly when it comes to audio volume settings while listening to a radio, television, telephone, and so forth. For example, elderly adults may need to turn up the volume while children may need to keep the volume at a lower setting, especially for infants who have sensitive, developing eardrums.

A problem in the art of auditory volume control is a lack of intelligent volume customization for individual users, within a defined space containing multiple users and multiple speakers corresponding to a particular user (i.e., in a theater, a car, a living room, and so forth).

### BRIEF SUMMARY

Embodiments of the present invention disclose a method, a computer program product, and a system.

A method, according to an embodiment of the invention, in a data processing system including a processor and a memory, for implementing a program that separately adjusts audio volume for a plurality of zone speakers in a space having a plurality of zones is provided. The method includes detecting one or more internet of things (IoT) devices within the plurality of zones. The method further includes associating the one or more detected IoT devices, within the plurality of zones, with a corresponding zone speaker, and adjusting, separately, the audio volume of the plurality of zone speakers based on one or more audio volume settings associated with the one or more detected IoT devices.

A computer program product, according to an embodiment of the invention, includes a non-transitory tangible storage device having program code embodied therewith. The program code is executable by a processor of a computer to perform a method. The method includes detecting one or more internet of things (IoT) devices within the plurality of zones. The method further includes associating the one or more detected IoT devices, within the plurality of zones, with a corresponding zone speaker, and adjusting, separately, the audio volume of the plurality of zone speakers based on one or more audio volume settings associated with the one or more detected IoT devices.

A computer system, according to an embodiment of the invention, includes one or more computer devices each having one or more processors and one or more tangible storage devices; and a program embodied on at least one of the one or more storage devices, the program having a plurality of program instructions for execution by the one or more processors. The program instructions implement a method. The method includes detecting one or more internet of things (IoT) devices within the plurality of zones. The method further includes associating the one or more detected IoT devices, within the plurality of zones, with a corresponding zone speaker, and adjusting, separately, the audio volume of the plurality of zone speakers based on one or more audio volume settings associated with the one or more detected IoT devices.

### BRIEF DESCRIPTION OF THE DRAWINGS

FIG. 1 illustrates an audio volume adjustment computing environment, in accordance with an embodiment of the present invention.

FIG. 2 is a flowchart illustrating the operation of audio volume adjustment program 120 of FIG. 1, in accordance with an embodiment of the present invention.

FIG. 3 illustrates a use case of audio volume adjustment program 120 of FIG. 1, in accordance with an embodiment of the present invention.

FIG. 4 is a diagram graphically illustrating the hardware components of audio volume adjustment computing environment of FIG. 1, in accordance with an embodiment of the present invention.

FIG. 5 depicts a cloud computing environment, in accordance with an embodiment of the present invention.

FIG. 6 depicts abstraction model layers of the illustrative cloud computing environment of FIG. 5, in accordance with an embodiment of the present invention.

### DETAILED DESCRIPTION

The present invention discloses a method that dynamically adjusts the audio volume for each detected IoT user device, or user, in real-time based on matching the IoT user device, or user, with the speakers available at the current location of the IoT user device, or user, within a limited scope and space.

Through using IoT user devices to identify an individual, the present invention is capable of identifying the customized volume preferences of a user based on their unique volume specific profile, and matching the volume level with the customized volume preferences of the user at a specific location, or zone, within a vehicle or other defined space.

Hereinafter, exemplary embodiments of the present invention will be described in detail with reference to the attached drawings.

The present invention is not limited to the exemplary embodiments below, but may be implemented with various modifications within the scope of the present invention. In addition, the drawings used herein are for purposes of illustration, and may not show actual dimensions.

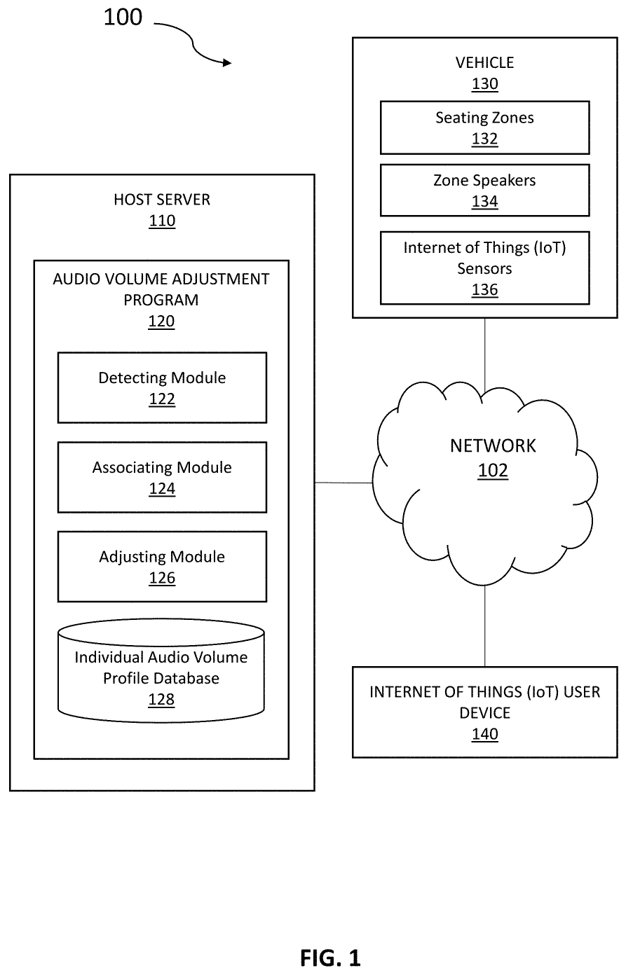

FIG. 1 illustrates audio volume adjustment computing environment 100, in accordance with an embodiment of the present invention. Audio volume adjustment computing environment 100 includes host server 110, vehicle 130, and internet of things (IoT) user device 140 all connected via network 102. The setup in FIG. 1 represents an example embodiment configuration for the present invention, and is not limited to the depicted setup in order to derive benefit from the present invention.

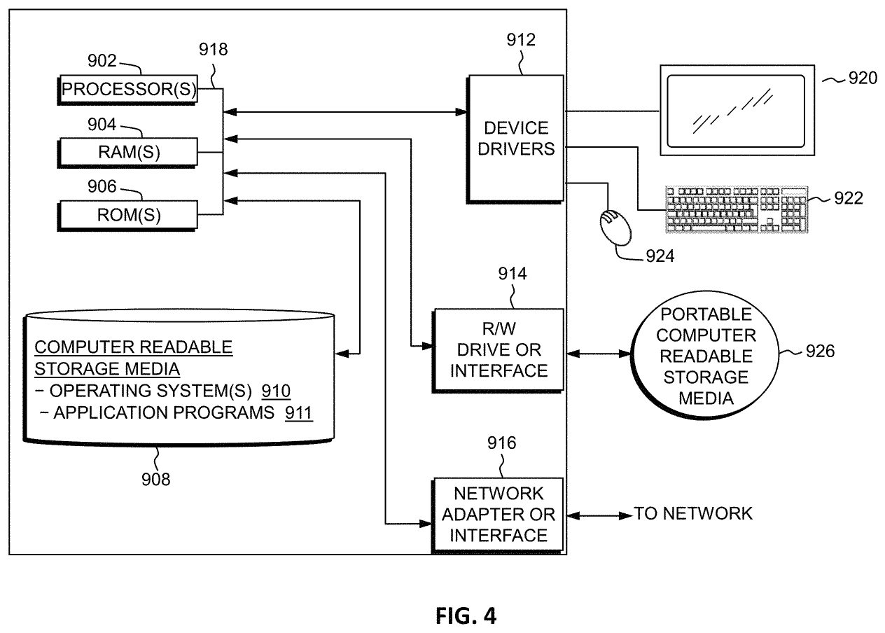

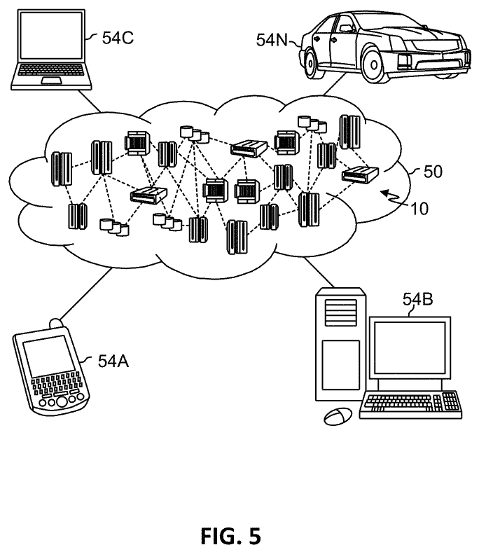

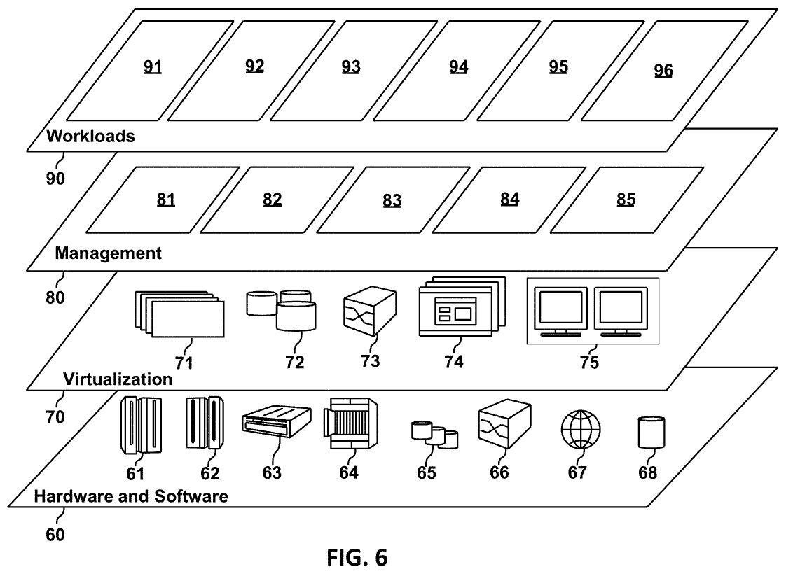

In the example embodiment, host server 110 contains audio volume adjustment program 120. In various embodiments, host server 110 may be a laptop computer, tablet computer, netbook computer, personal computer (PC), a desktop computer, a personal digital assistant (PDA), a smart phone, a server, or any programmable electronic device capable of communicating with vehicle 130 and IoT user devices 140 via network 102. Host server 110 may include internal and external hardware components, as depicted and described in further detail below with reference to FIG. 4. In other embodiments, host server 110 may be implemented in a cloud computing environment, as described in relation to FIGS. 5 and 6, herein. Host server 110 may also have wireless connectivity capabilities allowing it to communicate with vehicle 130, IoT user device 140, and other computers or servers over network 102.

With continued reference to FIG. 1, vehicle 130 contains seating zones 132, zone speakers 134, and internet of things (IoT) sensors 136. In exemplary embodiments, vehicle 130 may be a car, a minivan, a truck or any road vehicle containing one or more seats and one or more speakers. In alternative embodiments, vehicle 130 may be any vehicle containing one or more seats and one or more speakers, such as a vehicle that flies in the sky (e.g., airplane, rocket ship, hot-air balloon, hovercraft, etc.), a vehicle that floats on the water (e.g., motorboat, yacht, jet ski, pontoon, etc.), and any other vehicle known to one of ordinary skill in the art.

While the present application focuses primarily on customized audio volume control for passengers within a vehicle, the present invention is not limited to the defined space and scope of vehicles. For example, the present invention may be used in any defined space containing one or more zones, and corresponding speakers within the one or more zones, such as theatres, home viewing stations, classrooms, lecture halls, stadiums, concert halls, opera houses, parks, and so forth.

In exemplary embodiments, seating zones 132 may include a cluster of, or individual, seats, or standing/sitting areas, within a defined space, such as a concert in the park, a lecture within a large classroom, an area of an airplane or bus, and so forth. For example, one or more seating zones 132 may comprise individual seats within vehicle 130, such as the driver's seat, the front passenger seat, the rear left passenger seat, the rear center passenger seat, and the rear right passenger seat. With reference to a stadium or theatre, seating zones 132 may be organized based on a seat level (e.g., field/stage level, mezzanine, upper-level), an individual seat, or by any other means of organization.

In exemplary embodiments, the plurality of seating zones 132 includes pre-defined parameters. For example, the number of seats within vehicle 130, together with their respective spatial areas are defined (i.e., a driver's seat within vehicle 130 does not overlap with any other seats in vehicle 130). Likewise, zone speakers 134 coverage is mapped to its corresponding seating zones 132. In other words, a specific seat, or area, has a specific speaker defined for output to that specific seat, or area.

In exemplary embodiments, zone speakers 134 may include one or more speakers that correspond with seating zones 132. For example, the driver's seat in vehicle 130 may include a zone speaker 134 that may be customized for the pre-configured, or detected, audio volume levels of the driver who is occupying that seat. Similarly, the zone speakers 134 for the other individual seats within vehicle 130 may be individually tailored, or customized, for the audio volume settings of the occupants of the respective individual seats. In exemplary embodiments, individual zone speakers 134 within vehicle 130 may only be adjusted based on the individual audio volume preferences associated with the individual seating zones 132. In alternative embodiments, vehicle 130 may contain two seating zones 132: seating zone 1, the front seats; and seating zone 2, the back seats. In this scenario, zone speakers 134 may correspond to seating zone 1 and seating zone 2, rather than to individual seats within vehicle 130.

In other embodiments, such as a concert in the park, or a lecture within a tiered lecture hall, individual zone speakers 134 may not be present. In these scenarios, the defined concert space, or the defined lecture hall space, may be divided into one or more separate zones. The zones may comprise corresponding zone speakers 134.

In exemplary embodiments, IoT sensors 136 may include embedded computing systems that allow objects, such as IoT user device 140, to be sensed or controlled remotely across existing network infrastructure, such as network 102, thus creating opportunities for more direct integration of the physical world into computer-based systems, and resulting in improved efficiency, accuracy, and economic benefit in addition to reduced human intervention.

In various embodiments, IoT sensors 136 are embedded within various devices, such as IoT user device 140, that contain a computer processing unit (CPU), memory, and power resource, and may be capable of communicating with vehicle 130, IoT user device 140, and host server 110 over network 102.

In exemplary embodiments, IoT user device 140 may refer to a wide variety of devices such as a smartphone, a mobile device, a hearing aid, a smart watch, a key fob, wearables that are individual-specific (e.g., heart monitoring devices, tailored clothing, etc.), or any other type of device that is capable of connecting with vehicle 130. These IoT user devices 140 collect useful data with the help of various existing technologies and then autonomously flow the data between other devices.

In exemplary embodiments, vehicle 130 may be capable of communicating with IoT user device 140 via an internet of things (IoT) network comprised of IoT sensors 136. An IoT network may comprise a network of physical devices (e.g., smart phones, mobile devices, hearing aids, wearables, etc.) and other items embedded with electronics, sensors, actuators, and connectivity which enables these objects to connect and exchange data. For example, vehicle 130, via IoT sensors 136, may be capable of detecting the audio settings of a mobile device and incorporate those audio settings into the zone speakers 134 of a user sitting in a specific seat within vehicle 130.

In exemplary embodiments, each IoT user device 140 may be uniquely identifiable through its embedded computing system but is able to inter-operate within the existing Internet infrastructure. The IoT network, which includes IoT sensors 136, allows objects to be sensed or controlled remotely across existing network infrastructure, thereby creating opportunities for more direct integration of the physical world into a computer-based system resulting in improved efficiency, accuracy, and economic benefit in addition to reduced human intervention.

With continued reference to FIG. 1, audio volume adjustment program 120, in the example embodiment, may be a computer application on host server 110 that contains instruction sets, executable by a processor. The instruction sets may be described using a set of functional modules. In exemplary embodiments, audio volume adjustment program 120 may receive input from vehicle 130 and IoT user devices 140 over network 102. In alternative embodiments, audio volume adjustment program 120 may be a computer application contained within vehicle 130, or as a standalone program on a separate electronic device.

With continued reference to FIG. 1, the functional modules of audio volume adjustment program 120 include detecting module 122, associating module 124, adjusting module 126, and individual audio volume profile database 128.

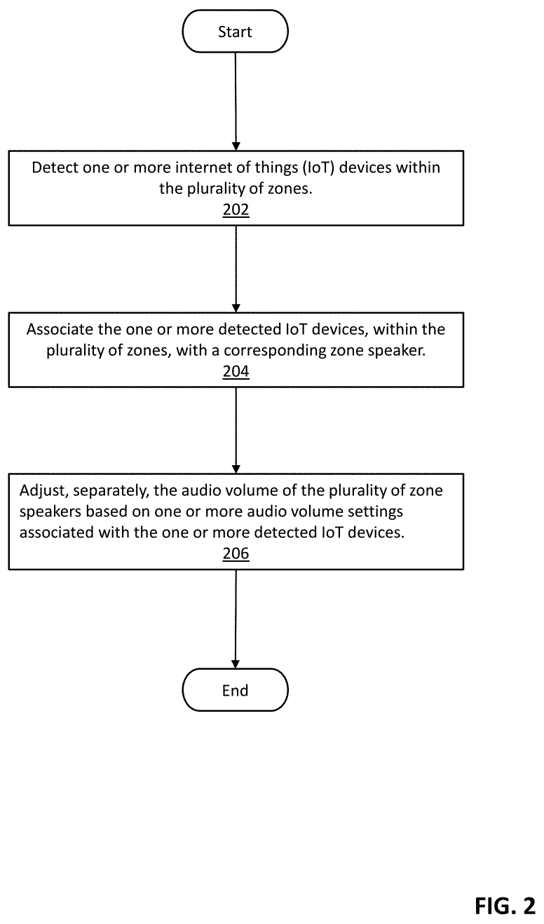

FIG. 2 is a flowchart illustrating the operation of audio volume adjustment program 120 of FIG. 1, in accordance with embodiments of the present invention.

With reference to FIGS. 1 and 2, detecting module 122 includes a set of programming instructions in audio volume adjustment program 120, to detect one or more internet of things (IoT) devices, such as IoT user device 140, within the plurality of zones (step 202). In exemplary embodiments, detecting module 122 may detect an IoT user device 140 via IoT sensors 136. An IoT user device 140 may contain personal identifiers (i.e., a username), a personal identification number (PIN), or an access code that is capable of being paired, or matched, with seating zones 132 and zone speakers 134 within vehicle 130 via BLUETOOTH, or over an IoT network.

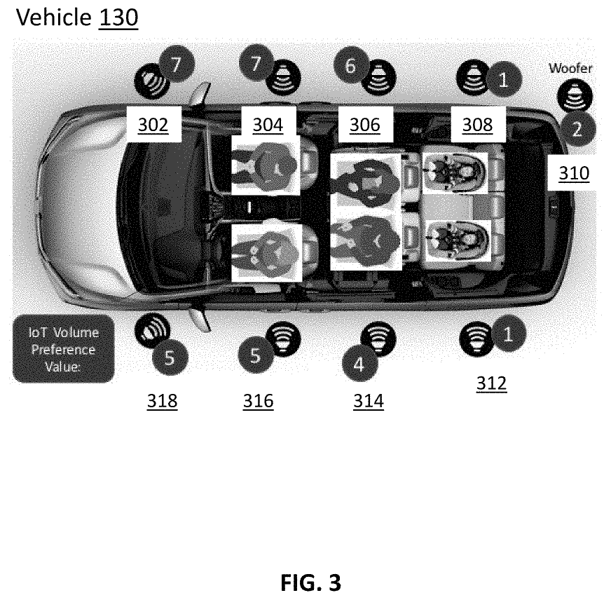

FIG. 3 illustrates a first use case of audio volume adjustment program 120 of FIG. 1, in accordance with an embodiment of the present invention.

With reference to an illustrative example, as depicted in FIG. 3, vehicle 130 includes six seating zones 132 with corresponding zone speakers 134. As depicted in FIG. 3, zone speakers 134 include 302-318, with an associated volume level (1-10) next to each zone speaker 134. Mary is sitting in the driver's seat. Detecting module 122 has identified Mary's smart phone, via IoT sensors 136, and is therefore capable of determining that Mary is sitting in the driver's seat of vehicle 130. Likewise, detecting module 122 identifies that Bob is sitting in the passenger seat behind Mary, based on identifying Bob's smart watch.

In exemplary embodiments, audio volume adjustment program 120 may be capable of building one or more audio volume profiles associated with the one or more detected IoT user devices 140.

With continued reference to FIGS. 1 and 2, associating module 124 includes a set of programming instructions in audio volume adjustment program 120, to associate the one or more detected IoT devices 140, within the plurality of zones, with a corresponding zone speaker 134 (step 204). The set of programming instructions is executable by a processor.

With continued reference to the illustrative example in FIG. 3, associating module 124 is capable of pairing Mary's smart phone with speakers 316 and 318, the zone speakers 134 associated with the driver's seat. Furthermore, associating module 124 associates speaker 314 with Bob's passenger seat directly behind Mary, based on Bob's detected smart watch corresponding to that location. If Mary no longer felt like driving and switches seats with Bob, then detecting module 122 may detect the corresponding IoT user devices 140 (i.e., Mary's smart phone and Bob's smart watch) at their respective changed seat locations within vehicle 130. Associating module 124 would then correctly pair Mary's smart phone and Bob's smart watch with the zone speakers 134 associated with their changed seats.

In alternative embodiments, associating module 124 may be capable of associating one or more users, within the plurality of zones, with the corresponding zone speakers 134 based on one or more of the following: image recognition, weight recognition, and voice recognition.

With reference to image recognition, a camera may be used to detect which user is sitting in which seat in vehicle 130 in order to identify a stored profile of the identified user. Image recognition may be useful for situations where a user does not carry a smart phone or wear a smart watch, such as a child, or situations where the user cannot be currently identified via their IoT user device 140.

With reference to weight recognition, a simple scale built into the seat of vehicle 130 may help to identify a user, based on detected weight, by matching this physical characteristic with a saved individual profile.

With reference to voice recognition, a microphone may be used to detect a user's voice. For example, a user may speak into the zone speaker 134 closest to them to identify themselves (e.g., “Watson, use my audio volume settings.”). Voice recognition technology may require a saved individual profile in order to match a user's voice with saved profile audio volume settings.

In exemplary embodiments, audio volume adjustment program 120 may be capable of building one or more audio volume profiles associated with the one or more users. For example, individual audio volume profiles may include an image of the user, weight of the user, a voice sample of the user, or any other identifying characteristic of the user that may assist in associating a user with a saved profile within individual audio volume profile database 128.

In exemplary embodiments, individual audio volume profile database 128 is local data storage on audio volume adjustment program 120 that may contain a list of one or more individual profiles associated with corresponding audio volume settings. The individual audio volume profile for a user may dynamically adjust based on a user's fluctuation in audio volume settings over time and use.

In alternative embodiments, individual audio volume profile database 128 includes identifying characteristics of one or more users, such as images, weight, voice sample, and so forth.

While individual audio volume profile database 128 is depicted as being stored on audio volume adjustment program 120, in other embodiments, individual audio volume profile database 128 may be stored on host server 110, vehicle 130, IoT user device 140, or any other device or database connected via network 102, as a separate database. In alternative embodiments, individual audio volume profile database 128 may be comprised of a cluster or plurality of computing devices, working together or working separately.

With continued reference to FIGS. 1 and 2, adjusting module 126 includes a set of programming instructions in audio volume adjustment program 120, to adjust the audio volume of each of the plurality of zone speakers 134, separately, based on one or more audio volume settings associated with the one or more detected IoT devices, such as IoT user device 140 (step 206). The set of programming instructions is executable by a processor.

In exemplary embodiments, audio volume settings may be pulled from IoT user device 140. For example, a smart phone may contain a saved volume setting in an installed media player application or a saved volume setting for a phone or teleconference application.

In other exemplary embodiments, audio volume settings may be associated with a saved individual audio volume profile.

With continued reference to the illustrative example in FIG. 3, Mary's smart phone includes audio volume settings set to her comfort level for listening to music. Mary's smart phone may also include a different set of audio volume settings for when Mary speaks on the telephone. Adjusting module 126 is capable of pulling Mary's audio settings from her device and incorporating them into speakers 316 and 318 without Mary having to manually adjust the audio volume settings. Similarly, if Mary receives a phone call while she is driving, adjusting module 126 adjusts the audio volume, based on Mary's pulled audio volume settings, for the duration of the phone call and reverts back to the audio volume settings for music listening.

With continued reference to the illustrative example in FIG. 3, Bob may have a saved individual audio volume profile associated with vehicle 130. For example, if Bob is not carrying or wearing an IoT user device 140, then audio volume adjustment program 120 may still be capable of customizing Bob's zone speakers 134 to his audio volume preferences, or settings, by accessing his saved individual audio volume profile in individual audio volume profile database 128 via image recognition, weight recognition, voice recognition, or any other method of identifying an individual profile known to one of ordinary skill in the art, as discussed above. Based on the identified individual audio volume profile of Bob, adjusting module 126 conforms the audio volume output of speaker 314 with Bob's saved audio volume settings.

In alternative embodiments, audio volume adjustment program 120 may be capable of detecting an action state of the one or more users, such as whether a user is sleeping or eating, or talking with another passenger in the car, and so forth. In such instances, adjusting module 126 may be further capable of adjusting, separately, the audio volume of the plurality of zone speakers 134 based on the detected action state of the one or more users.

With continued reference to the illustrative example in FIG. 3, the infants sitting in car seats associated with speakers 308 and 312 may be listening to lullabies at a volume of 4. Audio volume adjustment program 120 may detect that the infants have both fallen asleep, via image recognition or any other technology known to one of ordinary skill in the art, and adjusts the volume to 1, based on pre-configured preferences.

In alternative embodiments, audio volume adjustment program 120 may be capable of aggregating the plurality of zones, calculating an average audio volume for the one or more audio volume settings associated with the one or more detected IoT user devices 140, and adjusting the audio volume settings based on the calculated average audio volume over a defined coverage area.

With continued reference to the illustrative example in FIG. 3, audio volume adjustment program 120 detects the smart phones for the four people in the first two rows of vehicle 130, associated with speakers 302, 304, 306, 314, 316, and 318. Mary and Bob listen to the radio at a volume of 5 and 4, respectively. Mark and Jill listen to the radio at a volume of 7 and 6, respectively. The average audio volume between Mary, Bob, Mark, and Jill is 5.5. As such, audio volume adjustment program 120 outputs an audio volume of 5.5 for the first two rows of seats in vehicle 130, corresponding to speakers 302, 304, 306, 314, 316, and 318.

In further embodiments, audio volume adjustment program 120 may be capable of providing an option to override one or more audio sources, from a plurality of audio sources connected to the plurality of zone speakers 134.

With continued reference to the illustrative example in FIG. 3, if the group of passengers in vehicle 130 are listening to the radio and Mary (i.e., the driver) is using a navigation system to give turn-by-turn directions, audio volume adjustment program 120 may allow for Mark, Jill, and Bob to select the audio sources that they would like to listen to or not listen to. For example, Jill and Bob may not want to hear the directions broadcasted, over the zone speakers 134, by the navigation system and may therefore pre-set their corresponding zone speakers 134 to not broadcast the directions. Since Mark is sitting in the front passenger seat and wants to be sure that Mary is following the directions from the navigation system, he may pre-set his audio settings to allow for the navigation system to broadcast over his associated zone speakers 134.

In the example embodiment, network 102 is a communication channel capable of transferring data between connected devices and may be a telecommunications network used to facilitate telephone calls between two or more parties comprising a landline network, a wireless network, a closed network, a satellite network, or any combination thereof. In another embodiment, network 102 may be the Internet, representing a worldwide collection of networks and gateways to support communications between devices connected to the Internet. In this other embodiment, network 102 may include, for example, wired, wireless, or fiber optic connections which may be implemented as an intranet network, a local area network (LAN), a wide area network (WAN), or any combination thereof. In further embodiments, network 102 may be a Bluetooth network, a WiFi network, or a combination thereof. In general, network 102 can be any combination of connections and protocols that will support communications between host server 110, vehicle 130, and IoT user device 140.

FIG. 4 is a block diagram depicting components of a computing device (such as host server 110, as shown in FIG. 1), in accordance with an embodiment of the present invention. It should be appreciated that FIG. 4 provides only an illustration of one implementation and does not imply any limitations with regard to the environments in which different embodiments may be implemented. Many modifications to the depicted environment may be made.

Host server 110 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, such as audio volume adjustment program 120, may be stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Host server 110 may also include a R/W drive or interface 914 to read from and write to one or more portable computer readable storage media 926. Application programs 911 on host server 110 may be stored on one or more of the portable computer readable storage media 926, read via the respective R/W drive or interface 914 and loaded into the respective computer readable storage media 908.

Host server 110 may also include a network adapter or interface 916, such as a TCP/IP adapter card or wireless communication adapter (such as a 4G wireless communication adapter using OFDMA technology). Application programs 911 on host server 110 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

Host server 110 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and controlling access to data objects 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Based on the foregoing, a computer system, method, and computer program product have been disclosed. However, numerous modifications and substitutions can be made without deviating from the scope of the present invention. Therefore, the present invention has been disclosed by way of example and not limitation.

1. A computer-implemented method for separately adjusting audio volume for a plurality of zone speakers in a space having a plurality of zones, comprising:
detecting, automatically, one or more internet of things (IoT) devices, associated with one or more users, within the plurality of zones, wherein the detected one or more IoT devices associated with the one or more users includes audio volume preferences for the one or more users;
detecting an action state of the one or more users;
associating, automatically, the one or more detected IoT devices, within the plurality of zones, with a corresponding zone speaker;
associating, automatically, the one or more users, within the plurality of zones, with the corresponding zone speaker based on one or more of the following: image recognition, weight recognition, and voice recognition;
adjusting, automatically, the audio volume of the corresponding zone speaker based on the audio volume preferences associated with the detected one or more IoT devices; and
adjusting, automatically, the audio volume of the corresponding zone speaker based on the detected action state of the one or more users, wherein the detected action state of the one or more users includes at least one of the following: sleeping, eating, talking on a mobile device, and talking with one or more other users.

2. The computer-implemented method of claim 1, further comprising:
building one or more audio volume profiles associated with the one or more detected IoT devices.

3. (canceled)

4. The computer-implemented method of claim 1, further comprising:
building one or more audio volume profiles associated with the one or more users.

5. (canceled)

6. The computer-implemented method of claim 1, wherein the plurality of zones comprise one or more pre-defined boundaries that separate one or more zones from the plurality of zones in the space.

7. The computer-implemented method of claim 1, further comprising:
aggregating the plurality of zones;
calculating an average audio volume for the one or more audio volume preferences associated with the detected one or more IoT devices within the aggregated plurality of zones; and
adjusting the audio volume output within the aggregated plurality of zones based on the calculated average audio volume for the one or more audio volume preferences associated with the one or more detected IoT devices over a defined coverage area.

8. The computer-implemented method of claim 1, further comprising:
providing an option to override one or more audio sources, from a plurality of audio sources, associated with the one or more detected IoT devices and the corresponding zone speaker, within the plurality of zones.

9. A computer program product, comprising a non-transitory tangible storage device having program code embodied therewith, the program code executable by a processor of a computer to perform a method, the method comprising:
detecting, automatically, one or more internet of things (IoT) devices, associated with one or more users, within the plurality of zones, wherein the detected one or more IoT devices associated with the one or more users includes audio volume preferences for the one or more users;
detecting an action state of the one or more users;
associating, automatically, the one or more detected IoT devices, within the plurality of zones, with a corresponding zone speaker;
associating, automatically, the one or more users, within the plurality of zones, with the corresponding zone speaker based on one or more of the following: image recognition, weight recognition, and voice recognition;
adjusting, automatically, the audio volume of the corresponding zone speaker based on the audio volume preferences associated with the detected one or more IoT devices; and
adjusting, automatically, the audio volume of the corresponding zone speaker based on the detected action state of the one or more users, wherein the detected action state of the one or more users includes at least one of the following: sleeping, eating, talking on a mobile device, and talking with one or more other users.

10. The computer program product of claim 9, further comprising:
building one or more audio volume profiles associated with the one or more detected IoT devices.

11. (canceled)

12. The computer program product of claim 9, further comprising:
building one or more audio volume profiles associated with the one or more users.

13. (canceled)

14. The computer program product of claim 9, wherein the plurality of zones comprise one or more pre-defined boundaries that separate one or more zones from the plurality of zones in the space.

15. The computer program product of claim 9, further comprising:
aggregating the plurality of zones;
calculating an average audio volume for the one or more audio volume preferences associated with the detected one or more IoT devices within the aggregated plurality of zones; and
adjusting the audio volume output within the aggregated plurality of zones based on the calculated average audio volume for the one or more audio volume preferences associated with the one or more detected IoT devices over a defined coverage area.

16. The computer program product of claim 9, further comprising:
providing an option to override one or more audio sources, from a plurality of audio sources, associated with the one or more detected IoT devices and the corresponding zone speaker, within the plurality of zones.

17. A computer system, comprising:
one or more computer devices each having one or more processors and one or more tangible storage devices; and
a program embodied on at least one of the one or more storage devices, the program having a plurality of program instructions for execution by the one or more processors, the program instructions comprising instructions for:
detecting, automatically, one or more internet of things (IoT) devices, associated with one or more users, within the plurality of zones, wherein the detected one or more IoT devices associated with the one or more users includes audio volume preferences for the one or more users;
detecting an action state of the one or more users;
associating, automatically, the one or more detected IoT devices, within the plurality of zones, with a corresponding zone speaker;
associating, automatically, the one or more users, within the plurality of zones, with the corresponding zone speaker based on one or more of the following: image recognition, weight recognition, and voice recognition;
adjusting, automatically, the audio volume of the corresponding zone speaker based on the audio volume preferences associated with the detected one or more IoT devices; and
adjusting, automatically, the audio volume of the corresponding zone speaker based on the detected action state of the one or more users, wherein the detected action state of the one or more users includes at least one of the following: sleeping, eating, talking on a mobile device, and talking with one or more other users.

18. The computer system of claim 17, further comprising:
building one or more audio volume profiles associated with the one or more detected IoT devices.

19. (canceled)

20. The computer system of claim 17, further comprising:
building one or more audio volume profiles associated with the one or more users.
